(19) United States
(12) Patent Application Publication
(10) Pub. No.: US 2008/0025413 A1
(43) Pub. Date: Jan. 31, 2008

(54) Selecting bit rates for encoding multiple data streams

(76) Inventor: John Apostolopoulos, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/494,929

(22) Filed: Jul. 28, 2006

(51) Int. Cl. H04N 7/12

(52) U.S. Cl. 375/240.26

(57) ABSTRACT

Processing of data streams is described. Respective bit rates at which the data streams can be encoded are selected. The respective bit rates when summed do not exceed a bit rate threshold. An effect on the data streams if the data streams are encoded at the respective bit rates is determined. If the effect is unsatisfactory relative to a target, a different set of respective bit rates at which the data streams can be encoded is selected. The different respective bit rates, when summed, do not exceed the bit rate threshold. Once bit rates that permit the target to be satisfied are determined, the data streams can be encoded at those bit rates.

### TECHNICAL FIELD

Embodiments in accordance with the present invention relate to data processing and data delivery.

### BACKGROUND ART

Video conferencing is an effective way to conduct meetings between groups of people who are at different locations. To increase the effectiveness of video conferencing, multiple cameras and multiple displays are often used. For example, there may be three cameras and three display screens at each location. The feeds (data streams) from the cameras at one location are streamed to the other location, where they are displayed on respective screens, and vice versa. To preserve bandwidth on the network connection (channel) that links the two video conferencing locations, the data stream from each camera is encoded (compressed) independently on separate encoders.

The streaming channel is typically a leased line or part of a dedicated network. Such a channel generally supports a constant bit rate (CBR) that is shared by each of the encoders. If there are N encoders, then each of them is allocated 1/N of the CBR. Thus, each encoder is allocated the same amount of bandwidth, and encodes its respective feed for streaming at the same bit rate.

A disadvantage to the conventional approach is that it is inefficient in many situations. An encoder is allocated 1/N of the available bandwidth but may not require that amount of bandwidth. For example, the feed to one of the encoders may consist only of a static image. Once the first frame of the static image is encoded and sent over the streaming channel, very little bandwidth is subsequently needed by that encoder. Hence, the bandwidth allocated to that encoder is underutilized. Similarly, the feed to one of the encoders may be quite complex, and the encoder may have insufficient bit rate available to adequately encode that feed. Once again, the bandwidth allocation would be unsatisfactory.

Accordingly, there is value to an encoding system that can more efficiently use the bandwidth available, in particular when there are multiple input feeds.

### DISCLOSURE OF THE INVENTION

Processing of data streams is described. In one embodiment, respective bit rates at which the data streams can be encoded are selected. The respective bit rates when summed do not exceed a bit rate threshold. An effect on the data streams if the data streams are encoded at the respective bit rates is determined. If the effect is unsatisfactory relative to a target, a different set of respective bit rates at which the data streams can be encoded is selected. The different respective bit rates, when summed, do not exceed the bit rate threshold. Once bit rates that permit the target to be satisfied are determined, the data streams can be encoded at those bit rates.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram showing an example of a system upon which embodiments of the present invention can be implemented.

FIG. 2 is a block diagram showing another example of a system upon which embodiments of the present invention can be implemented.

FIG. 3 is a block diagram of one example of an encoder according to embodiments of the present invention.

FIG. 4 illustrates a number of frames being combined into a superframe according to an embodiment of the present invention.

FIG. 5 illustrates two superframes according to an embodiment of the present invention.

FIG. 6 is a flowchart of a method for processing data in accordance with an embodiment of the present invention.

FIG. 7 illustrates bit rates as a function of time according to an embodiment of the present invention.

FIG. 8 is a block diagram of a system for managing the processing of data according to an embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

The descriptions and examples provided herein are generally applicable to different types of data. In particular, the descriptions and examples provided herein are applicable to media data (also referred to herein as multimedia data or media content). One example of media data is video data accompanied by audio data. The video data may be compressed (encoded) using any of a variety of coding standards including, but not limited to, Moving Pictures Experts Group (MPEG) 1/2/4, MPEG-4 Advanced Video Coding (AVC), H.261/2/314, JPEG (Joint Photographic Experts Group) including Motion JPEG, JPEG 2000 including Motion JPEG 2000, and 3-D subband coding.

For simplicity of discussion, embodiments in accordance with the present invention are discussed in the context of a video conference in which encoded data flows in one direction between two locations. More generally speaking, embodiments in accordance with the present invention may be utilized in any application in which media (e.g., video) data is being sent between two locations, either in one direction or in both directions. Even more generally speaking, embodiments in accordance with the present invention may be utilized in any application in which compressible data is sent between any number of devices, regardless of their respective locations.

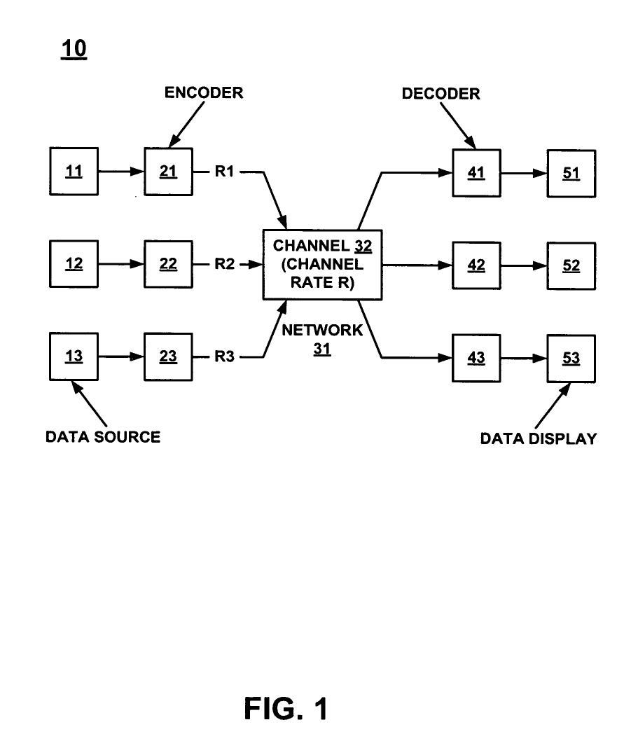

FIG. 1 is a block diagram showing one example of a system 10 upon which embodiments of the present invention can be implemented. In the example of FIG. 1, system 10 includes a number of functional elements connected in series, including but not limited to: data sources 11,12 and 13; encoders 21, 22 and 23; a network 31 that includes a channel 32; decoders 41, 42 and 43; and data displays 51, 52 and 53.

In one embodiment, data sources 11-13 are image capture devices, such as video cameras, that record live events as digital data in real time. Video data is generally captured frame by frame at a specified frame rate, usually measured as frames per second.

Each data source 11-13 outputs a data stream that is received by the encoders 21-23. Encoders 21-23 encode (compress) the raw data captured by the data sources 11-13, generally encoding one frame at a time, although each frame may be encoded using information from other frames as part of the encoding process. Encoders 21-23 can encode data at a constant bit rate (CBR) or at a variable bit rate (VBR) as a function of time. Variable bit rate coding can be used to encode the video at a constant quality as a function of time, as the encoded bit rate may then be increased or decreased to compensate for the time-varying complexity of the video. The encoders 21-23 are also tunable—that is, the encoders 21-23 can encode data at a specified bit rate or at a bit rate that is derived based on encoding parameters specified for the encoder. In addition to bit rate, encoding parameters can include, but are not limited to, frame rate, spatial resolution, quality in terms of signal-to-noise ratio (SNR), and information about the amount of motion (e.g., motion activity and motion search range).

The encoders 21-23 each output an encoded data stream. The encoded data is transmitted (e.g., streamed) over network 31 (channel 32) to the decoders 41-43. Network 31, in particular channel 32, may be a wired or wireless network or a combination thereof. There may be any number of devices situated on the path between the encoders 21-23 and the decoders 41-43, including storage devices. Data displays 51-53 may be conventional television monitors or the like.

Although FIG. 1 illustrates three data sources 11-13, three encoders 21-23, three decoders 41-43, and three data displays 51-53, there may be any number of such elements. Also, although the functional elements of FIG. 1 are illustrated as separate blocks, the functionality associated with those blocks may be performed using a single device or using multiple devices, or combinations thereof. For example, data source 11 and encoder 21 may be implemented as a single device (e.g., as a video camera that incorporates an encoder) or as separate devices. In one embodiment, the number of data sources, encoders, decoders and data displays is the same (e.g., three of each). That is, in one embodiment, there is an encoder for each data source or data stream, and a decoder for each data stream or data display.

In one embodiment, data sources 11-13 and encoders 21-23 are physically situated in one location such as a first video conferencing room, and decoders 41-43 and data displays 51-53 are physically situated in another location such as a second video conferencing room. Although not shown in FIG. 1, the first video conferencing room is, in general, also equipped with decoders and displays, and the second video conferencing room is, in general, also equipped with data sources and encoders. Thus, encoded information can flow in either direction.

In the example of FIG. 1, a video conference transpiring via channel 32 is allocated a channel rate R (in terms of bits per unit of time), which may be all of or a part of the bandwidth available on channel 32. The channel rate R that is allocated for the video conference may be constant for the duration of the video conference, or it may change with time.

In the example of FIG. 1, according to embodiments of the present invention, the encoders 21-23 are allocated amounts of the channel rate R depending on the complexity of the video data that they have to encode. For example, the video from data source (e.g., video camera) 11 may contain complex or moving imagery, while the video from data sources 12 and 13 may be relatively simple and perhaps static. This may be the case when a person moves while in the field of view of one camera but is not in the field of view of the other cameras. In this case, encoder 21 would have more complex video data to encode in comparison to encoders 22 and 23. Consequently, according to embodiments of the present invention, more of the channel rate R is allocated to encoder 21 then to encoders 22 and 23. Thus, in contrast to conventional approaches in which each encoder is allocated an equal share of the channel rate, the encoders 21-23 can each be allocated different amounts (R1, R2 and R3) of the channel rate, with the constraint that the sum of the bit rates allocated to the various encoders does not exceed the channel rate R (R1+R2+R3≦R).

In overview, an initial set of bit rate values is specified for each of the encoders 21-23. The effect on the video that would be reconstructed from data encoded using the set of initial bit rates is determined. If the effect is satisfactory, then the data can be encoded using those bit rates. If not, then a different set of bit rates can be specified. This iterative process can be repeated until the effect on the reconstructed video is satisfactory, for example minimizing the total distortion summed over all of the videos or minimizing the maximum distortion for any of the videos, or minimizing a perceptual distortion.

In one embodiment, the encoders 21-23 exchange information amongst themselves, or with a separate control or management element (not shown in FIG. 1), about their respective rate-distortion (R-D) performances at the set of bit rate values under consideration. For example, each encoder 21, 22 and 23 can specify the quality (in terms of peak signal-to-noise ratio or mean-squared error distortion) that would be achieved in the reconstructed video if the video data were to be encoded at the respective bit rates initially specified for each of the encoders. Equivalently, each encoder 21-23 can specify the distortion that would be present in the reconstructed video if the video data were to be encoded at the respective bit rates initially specified for each of the encoders.

In one embodiment, the respective values of quality or distortion from each of the encoders 21-23 are combined (e.g., summed) and compared to a threshold. In one such embodiment, if the combined (total) quality (or total amount of distortion) in the reconstructed video would not be satisfactory relative to the threshold, then new respective bit rates that are different from the initial values can be specified. The respective bit rates are adjusted if need be and may continue to be adjusted until the total quality level or the total distortion level across the encoders 21-23 satisfies the threshold. Once a final set of bit rates that permits the threshold to be satisfied is identified, the video data can be encoded by the encoders 21-23 using those bit rates.

In this manner, the encoders 21-23 vary their respective bit rates until total quality is satisfactory and perhaps maximized (or until total distortion is satisfactory and perhaps minimized). In one embodiment, this can be achieved by generating an R-D curve for each of the data streams, and then operating each encoder at the respective bit rate that corresponds to the points on the respective R-D curves that have the same slope. For example, the bit rate allocated for each encoder may be increased or decreased so that all of the encoders operate at the same slope in terms of rate/distortion.

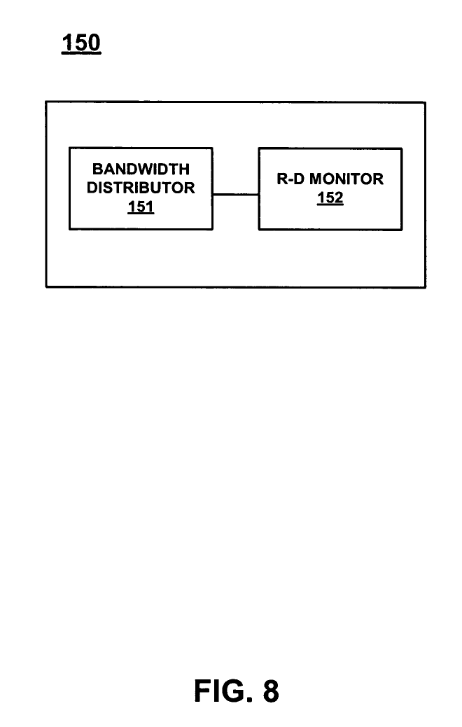

As mentioned above, in one embodiment, the encoders 21-23 exchange information amongst themselves, or exchange information with a separate control or management element (not shown in FIG. 1, but described in conjunction with FIG. 8, below). The control element may reside on one of the data sources 11-13 or on one of the encoders 21-23. Alternatively, the control element may be embodied as a separate device. In either case, the control element may draw information from the data sources 11-13 (in other words, from upstream of the encoders 21-23) and/or from the encoders 21-23 (in other words, from downstream of the encoders). Accordingly, the control element can evaluate the raw image data captured by the data sources 11-13 and, using known techniques, specify respective bit rates and/or other encoding parameters for each of the encoders 21-23. Also, the control element can evaluate the output of the encoders 21-23 and specify different bit rates and/or encoding parameters if need be. Furthermore, based on the output of the encoders 21-23, the control element can also specify bit rates and/or other encoding parameters for encoding the next frame of video data.

System 10 is advantageous because the available bandwidth (e.g., the channel rate R) is appropriately distributed across the encoders in a manner that improves aggregate quality (reduces aggregate distortion), given the available bandwidth. An encoder or encoders that have to encode more complex data can be allocated a larger share of the available bandwidth. Depending on the nature of the data to be encoded by each of the encoders 21-23, perhaps nearly all of the available bandwidth can be allocated to any one of the encoders.

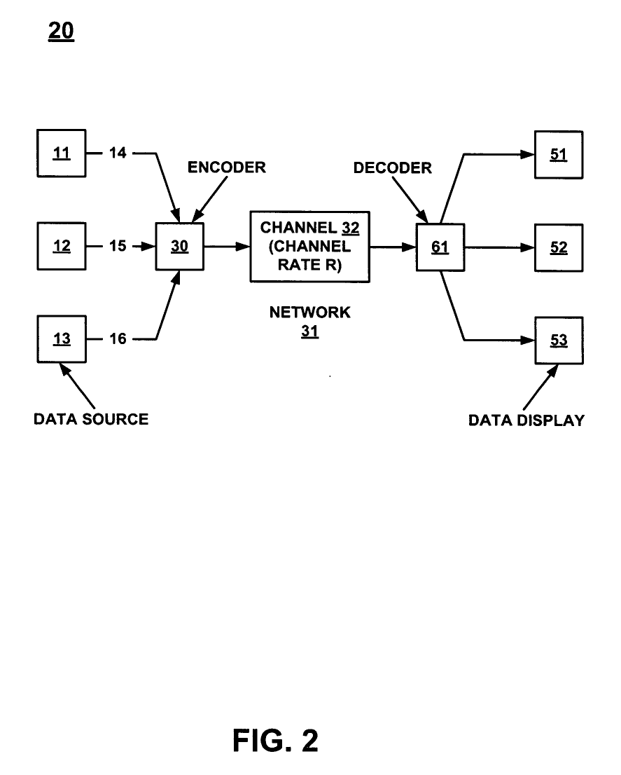

FIG. 2 is a block diagram showing another example of a system 20 upon which embodiments of the present invention can be implemented. In comparison to the example of FIG. 1, system 20 utilizes a single encoder 30 instead of multiple encoders. In one embodiment, a single decoder 61 is also used. Except for these differences and their implications, system 10 and system 20 operate in a similar manner.

System 20 is advantageous because, in the example of video conferencing, the different data streams may contain overlapping data. For example, a person's arm may be present within the field of view of two video cameras. As another example, a person or object may move from one camera's field of view into the field of view of another camera. By using a single encoder, an object that was previously encoded as part of a data stream from one video camera does not have to be re-encoded simply because the object now appears as part of a data stream from another video camera. Instead, the encoded data representing the object can be utilized by any data stream in which the object appears. As yet another example, if the background is the same across each of the video streams, then once it is encoded in one stream, the encoded background can be copied into the other streams. Thus, using a single encoder to encode multiple data streams can make processing more efficient.

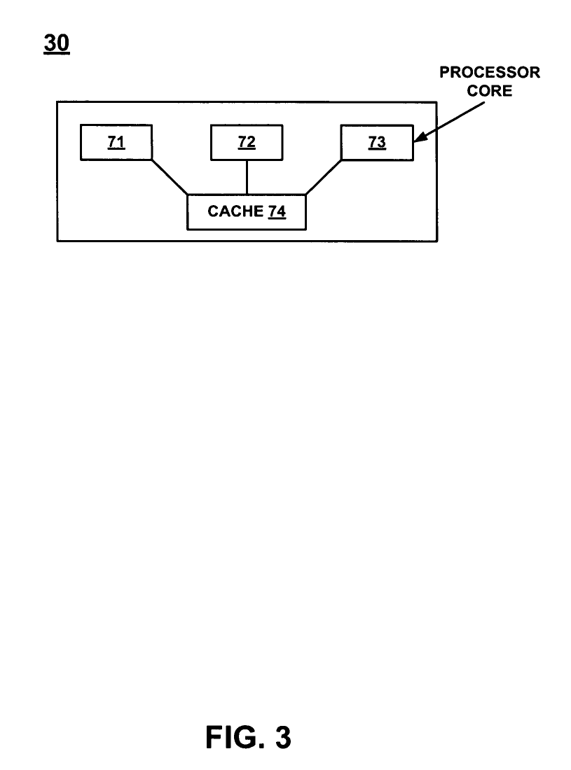

FIG. 3 is a block diagram of one embodiment of encoder 30 of FIG. 2. In the example of FIG. 3, encoder 30 includes multiple processor cores 71, 72 and 73, each coupled to an on-chip cache 74. Although three processor cores are illustrated, the present invention is not so limited. In general, with reference also to FIG. 2, there may be at least one processor core per data stream—in other words, at least one processor core per data source 11, 12 or 13. Alternatively, there may be more data sources than processor cores and therefore at least one processor core may process more than one data source. The data in cache 74 is equally accessible to each of the processor cores 71-73.

Instead of a multi-core processor coupled to a cache, encoder 30 can utilize other architectures or platforms. For example, encoder 30 may include multiple processors coupled to cache 74, or a single processor coupled to cache 74.

Continuing with reference to FIGS. 2 and 3, the data streams 14, 15 and 16 are stored in the cache 74 as “superframes.” Each of the data streams 14-16 contains a series of frames of raw image data. The raw image data is captured at the same time, or approximately the same time, by the data sources 11-13; thus, data streams 14-16 will each contain a frame of data captured at time T.

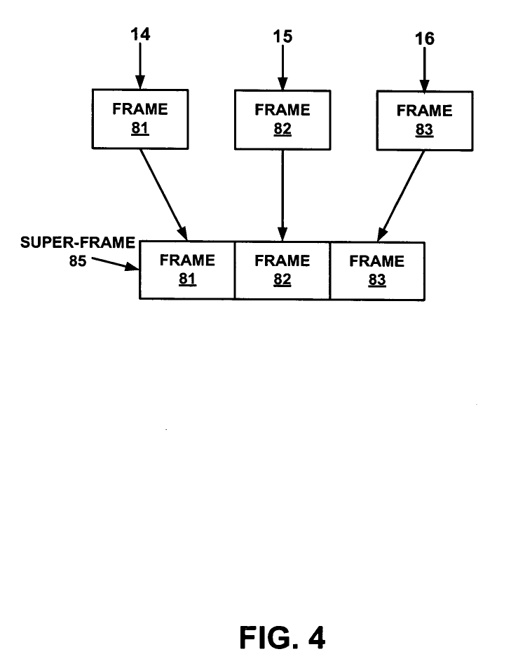

FIG. 4 illustrates a number of frames 81, 82 and 83 being combined into a superframe 85 according to an embodiment of the present invention. Frames 81-83 were captured at the same time T. Superframe 85 is created by compositing the frames 81-83, side by side. If, for example, each of the frames 81-83 has a resolution of M×N pixels, where M is the number of rows and N is the number of columns, then the size of superframe 85 is M×(3N).

Encoder 30 of FIGS. 2 and 3 can keep track of the boundaries between the frames 81-83 within superframe 85 and use the boundary information to adjust the encoding. For example, the boundary information can be used to partition superframe 85 into independently encoded (and decodable) regions, which may for example be included in separate network adaptation layer (NAL) packets using H.264/MPEG-4 AVC video encoding.

Alignment of image data from one frame to the next within superframe 85 (e.g., proper alignment of an object that lies across the boundary between adjacent frames 81-83) and treatment of overlapping image data (e.g., when the field of view of two video cameras overlap to some extent) are handled using techniques known in the art.

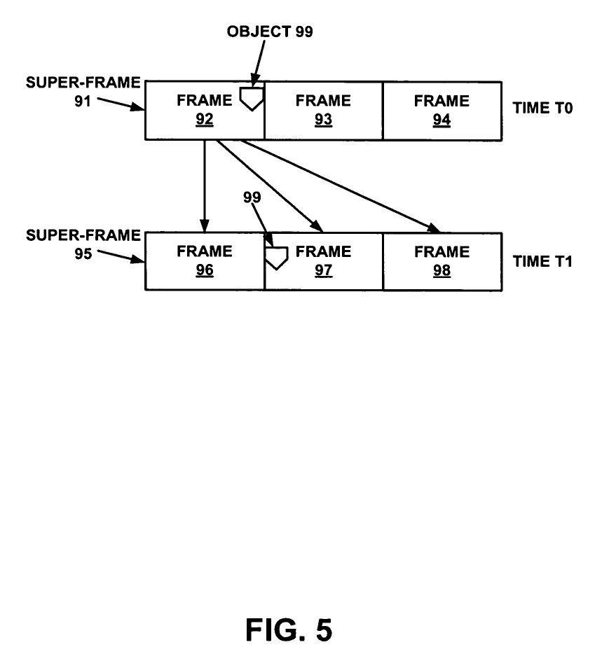

FIG. 5 illustrates two superframes 91 and 95 according to an embodiment of the present invention. Superframe 91 includes a composite (mosaic) of frames 92, 93 and 94 captured at time T0, and superframe 95 includes a composite of frames 96, 97 and 98 captured at time T1.

In the example of FIG. 5, any of the frames 92-94 can be used to predictively encode any of the frames 96-98. For example, any of the frames 96-98 can be predictively encoded from frame 92, as shown in FIG. 5. Similarly, frame 96 can be predicted from any or all of the frames 92-94.

Furthermore, in the example of FIG. 5, both frame 92 and frame 97 include the same object 99. Object 99 may be encoded when frame 92 is encoded. The encoded data representing object 99 can be subsequently used during the encoding of frame 97. In effect, the encoding of object 99 is accomplished regardless of which data stream it appears in, and the encoding of object 99 can be passed from one data stream to another.

The examples above can be achieved using video compression standards such as those mentioned previously herein, and using reference picture selection (RPS) or NewPred.

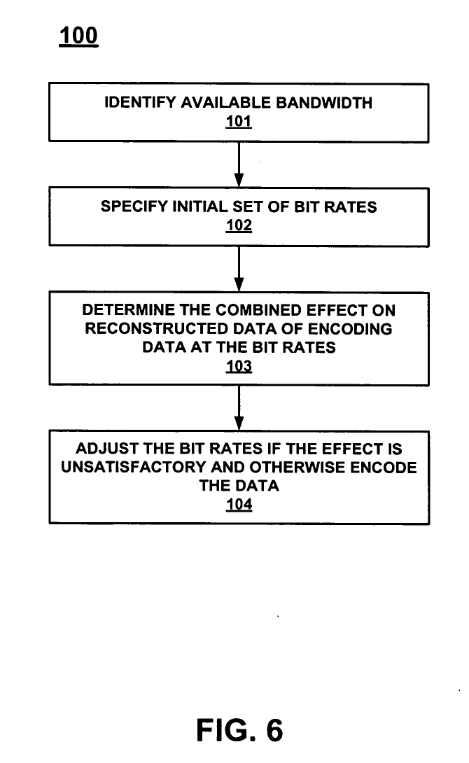

FIG. 6 is a flowchart 100 of a method for processing data in accordance with an embodiment of the present invention. Although specific steps are disclosed in flowchart 100, such steps are exemplary. That is, embodiments of the present invention are well-suited to performing various other steps or variations of the steps recited in flowchart 100. The steps in flowchart 100 may be performed in an order different than presented, and not all of the steps in flowchart 100 may be performed. All of, or a portion of, the methods described by flowchart 100 may be implemented using computer-readable and computer-executable instructions which reside, for example, in computer-usable media of a computer system.

In block 101, an amount of bandwidth (e.g., a channel rate R) that is available for delivering encoded data streams is identified.

In block 102, an initial set of bit rates at which the data streams can be respectively encoded is specified for each data stream.

In block 103, the effects on reconstructed versions of the data streams if the data streams were to be encoded at the initial set of respective bit rates is determined for each data stream. That is, a measure of distortion or a measure of quality of the reconstructed data is determined for each data stream, for example for each frame of each video stream. The effect on the individual data streams is combined (e.g., summed) to determine a combined effect.

In block 104, if the combined effect is unsatisfactory relative to a target, then a different set of respective bit rates at which the data streams can be encoded is specified such that, when the data streams are encoded at the different respective bit rates, the combined effect satisfies the target. Consequently, the amount of bandwidth may be non-uniformly (asymmetrically) apportioned to the data streams. For example, if the distortion for one data stream is larger than the other data streams, then some bit rate resource can be reallocated from the streams with low distortion to the stream with higher distortion. This reallocation may be performed to achieve the same distortion for each data stream. Alternatively, this reallocation may be performed to minimize the total distortion summed over all of the data streams (in which case all of the data streams will operate at the same slope on their rate-distortion curves). Alternatively, this reallocation may be performed to minimize a perceptual distortion across one or all of the data streams.

In one embodiment, the data streams are encoded by a plurality of encoders, where the number of data streams and encoders is the same. In another embodiment, the data streams are encoded by a single encoder. In the latter embodiment, a video frame of one data stream is combined with one or more other video frames from one or more other data streams to form a first superframe. The encoder encodes a second superframe, which also includes multiple video frames, using information included in the first superframe.

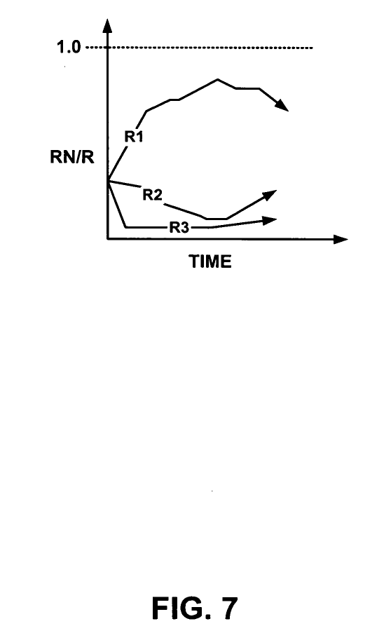

FIG. 7 illustrates bit rates R1, R2 and R3 as a function of time T according to an embodiment of the present invention. The values of the bit rates are normalized to the channel rate R. In the example of FIG. 7, the bit rates have values that are different from one another and that vary with time. At any point in time, the sum of the bit rates R1, R2 and R3 is less than or equal to (in other words, not greater than) the available bandwidth R. If the available bandwidth R should also vary as a function of time, then the respective bit rates R1, R2 and R3 can be adjusted and apportioned accordingly, such that the sum of the bit rates R1, R2 and R3 does not exceed R.

FIG. 8 is a block diagram of a system 150 for managing the processing of data according to an embodiment of the present invention. As mentioned above during the discussion of FIG. 1, system 150 may reside on one of the data sources 11-13 or on one of the encoders 21-23. Alternatively, system 150 may be embodied as a separate device. In either case, system 150 may draw information from the data sources 11-13 and/or from the encoders 21-23. Accordingly, system 150 can evaluate the raw image data captured by the data sources 11-13 and, using known techniques, specify respective bit rates and/or other encoding parameters,for each of the encoders 21-23. Also, system 150 can evaluate the output of the encoders 21-23 and specify different bit rates and/or encoding parameters if need be. Furthermore, based on the output of the encoders 21-23, system 150 can also specify bit rates and/or other encoding parameters for encoding the next frame or superframe of video data.

In the example of FIG. 8, system 150 includes a bandwidth distributor block 151 and an R-D monitor block 152. Bandwidth monitor 151 can be used to monitor the amount of bandwidth (e.g., the channel rate R) that is available to transmit encoded data streams, and can also be used to select the respective bit rates R1, R2 and R3 at which the data streams can be encoded. The R-D monitor 152 can be used to monitor a total measure of distortion across the encoded data streams as a function of time. If the total measure of distortion does not satisfy a target, the bandwidth distributor 152 can adjust the respective bit rates such that the target is satisfied.

In summary, embodiments in accordance with the present invention provide an encoding system that can more efficiently use available bandwidth, in particular in situations in which the bandwidth needs to be distributed among multiple data streams. By more efficiently utilizing the available bandwidth, and in particular by allocating a greater share of the bandwidth to the data stream or streams that need it the most, compression performance and the quality of the reconstructed video can be improved. Furthermore, because the total bit rate is more efficiently controlled, the network and communication elements in a data delivery system can be simplified and packet losses may be reduced, thereby further improving the quality of the reconstructed video.

As previously mentioned herein, embodiments in accordance with the present invention can be used in applications other than video conferencing and with other types of data besides media or video data.

Embodiments of the present invention are thus described. While the present invention has been described in particular embodiments, it should be appreciated that the present invention should not be construed as limited by such embodiments, but rather construed according to the following claims.

What is claimed is:

1. A method of processing a plurality of data streams output from a plurality of first devices, said method comprising:
selecting respective bit rates at which said data streams can be encoded, wherein said respective bit rates when summed do not exceed a bit rate threshold;
summing respective effects on said data streams if said data streams are encoded at said respective bit rates;
if a result of said summing is unsatisfactory relative to a target, selecting a different set of respective bit rates at which said data streams can be encoded such that a subsequent result of said summing satisfies said target, wherein said different set of respective bit rates when summed do not exceed said bit rate threshold, and wherein said data streams are then encoded at respective bit rates that permit said combined effect to satisfy said target.

2. The method of claim 1 wherein said data streams are encoded by a plurality of encoders, wherein there is a same number of data streams, first devices and encoders.

3. The method of claim 1 wherein said data streams are encoded by a single encoder.

4. The method of claim 3 further comprising:
combining a first video frame of a first data stream with a second video frame of a second data stream to form a first superframe, wherein said first and second video frames remain distinguishable from one another within said first superframe; and
encoding a second superframe comprising multiple video frames using information included in said first superframe.

5. The method of claim 3 wherein said encoder comprises an architecture selected from the group consisting of: a multi-core processor coupled to a cache; multiple processors coupled to a cache; and a processor coupled to a cache.

6. The method of claim 1 wherein said respective bit rates that permit said combined effect to satisfy said target are varied as a function of time.

7. The method of claim 1 wherein said respective bit rates that permit said combined effect to satisfy said target comprise bit rates that are different from one another.

8. A system for managing a plurality of data streams output from a plurality of devices, said system comprising:
a bandwidth distributor operable for monitoring an amount of bandwidth that is available to transmit encoded said data streams and for selecting respective bit rates at which said data streams can be encoded, wherein a sum of said respective bit rates does not exceed said amount of bandwidth; and
a rate-distortion monitor coupled to said bandwidth distributor and operable for monitoring a total measure of distortion across encoded said data streams as a function of time;
wherein, if said total measure of distortion does not satisfy a target, said bandwidth distributor adjusts said respective bit rates such that said target is satisfied, wherein a sum of adjusted said respective bit rates does not exceed said amount of bandwidth.

9. The system of claim 8 further comprising an encoder coupled to said bandwidth distributor and operable for encoding a data stream at a bit rate specified by said bandwidth distributor.

10. The system of claim 8 further comprising an encoder coupled to said bandwidth distributor and operable for encoding said plurality of data streams at respective bit rates specified by said bandwidth distributor.

11. The system of claim 10 wherein said encoder comprises an architecture selected from the group consisting of: a multi-core processor coupled to a cache; multiple processors coupled to a cache; and a processor coupled to a cache.

12. The system of claim 8 coupled to a plurality of encoders, wherein there is a same number of data streams and encoders.

13. The system of claim 8 wherein said respective bit rates that permit said total measure of distortion to satisfy said target are also varied as a function of time.

14. The system of claim 8 wherein said respective bit rates that permit said total measure of distortion to satisfy said target comprise bit rates that are different from one another.

15. A computer-usable medium having computer-readable code stored thereon for causing a device to perform a method of processing data streams, said method comprising:
accessing information that identifies an amount of bandwidth that is available for delivering encoded said data streams;
specifying respective bit rates at which said data streams can be encoded;
combining respective effects on said data streams if said data streams are encoded at said respective bit rates; and
if a result of said combining is unsatisfactory relative to a target, specifying different respective bit rates at which said data streams can be encoded such that, when said data streams are encoded at said different respective bit rates, a subsequent result of said combining satisfies said target, wherein said amount of bandwidth is non-uniformly apportioned to said data streams.

16. The computer-usable medium of claim 15 wherein said data streams are encoded by a plurality of encoders, wherein there is a same number of data streams and encoders.

17. The computer-usable medium of claim 15 wherein said data streams are encoded by a single encoder, wherein said encoder comprises an architecture selected from the group consisting of: a multi-core processor coupled to a cache; multiple processors coupled to a cache; and a processor coupled to a cache.

18. The computer-usable medium of claim 17 wherein said encoder combines a first video frame of a first data stream with a second video frame of a second data stream to form a first superframe, wherein said first and second video frames remain distinguishable from one another within said first superframe, and wherein said encoder encodes a second superframe comprising multiple video frames using information included in said first superframe.

19. The computer-usable medium of claim 15 wherein bit rates that permit said combined effect to satisfy said target are varied as a function of time.

20. The computer-usable medium of claim 15 wherein bit rates that permit said combined effect to satisfy said target comprise bit rates that are different from one another.
